(19) United States
(12) Patent Application Publication
(10) Pub. No.: US 2024/0080881 A1
(43) Pub. Date: Mar. 7, 2024

(54) METHODS, DEVICES, AND SYSTEMS FOR ENHANCING UPLINK COVERAGE

(71) Applicant: ZTE Corporation, Shenzhen (CN)

(72) Inventors: Jing Liu, Shenzhen (CN); He Huang, Shenzhen (CN)

(73) Assignee: ZTE Corporation, Shenzhen (CN)

(21) Appl. No.: 18/504,364

(22) Filed: Nov. 8, 2023

Related U.S. Application Data
(63) Continuation of application No. PCT/CN2021/110487, filed on Aug. 4, 2021.

(51) Int. Cl. H04W 74/00

(52) U.S. Cl. CPC H04W 74/004; H04W 74/008

(57) ABSTRACT

The present disclosure describes methods, systems and devices for enhancing uplink coverage. One method includes enhancing, by a user equipment (UE), an uplink coverage of a cell with a base station by receiving, by the UE, a configuration from the cell; determining, by the UE, a random access (RA) resource based on the configuration and a measured downlink signal strength; sending, by the UE, the RA preamble to the base station to request Msg3 repetition; and receiving, by the UE, an RA response from the base station indicating transmission resource for Msg3 repetition.

### TECHNICAL FIELD

The present disclosure is directed generally to wireless communications. Particularly, the present disclosure relates to methods, devices, and systems for enhancing uplink coverage.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

With the rapid evolution of cellular mobile communication systems, more and more cells will be operate at higher frequencies. For high frequency cells, the wireless channel may be subject to higher path-loss, which may result in smaller coverage compared to the cells utilizing lower frequency spectrum. There are problems or issues associated with the uplink transmission. For one example, for a given cell, the uplink coverage may be smaller than the downlink coverage, so that when a user equipment (UE) is at a cell edge, initial access procedure may fail due to the shortage of uplink transmission.

The present disclosure may address at least one of issues/problems associated with the existing system and describes various embodiments, thus improving the performance of the wireless communication.

### SUMMARY

This document relates to methods, systems, and devices for wireless communication and more specifically, for enhancing uplink coverage.

In one embodiment, the present disclosure describes a method for wireless communication. The method includes enhancing, by a user equipment (UE), an uplink coverage of a cell with a base station by receiving, by the UE, a configuration from the cell; determining, by the UE, a random access (RA) resource based on the configuration and a measured downlink signal strength; sending, by the UE, the RA preamble to the base station to request Msg3 repetition; and receiving, by the UE, an RA response from the base station indicating transmission resource for Msg3 repetition.

In another embodiment, the present disclosure describes a method for wireless communication. The method includes enhancing, by a base station, an uplink coverage of a cell for a user equipment (UE) by sending, by the base station, a configuration to the UE, so that the UE determines a random access (RA) resource based on the configuration and a measured downlink signal strength; receiving, by the base station, the RA preamble from the UE to request Msg3 repetition; and sending, by the base station, an RA response to the UE indicating transmission resource for Msg3 repetition.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4A shows a flow diagram of a method for wireless communication.

FIG. 4B shows a schematic diagram of a method for wireless communication.

FIG. 5 shows a flow diagram of a method for wireless communication.

FIG. 6 shows a schematic diagram of an exemplary embodiment for wireless communication.

FIG. 7 shows a schematic diagram of an exemplary embodiment for wireless communication.

FIG. 8 shows a schematic diagram of an exemplary embodiment for wireless communication.

FIG. 9 shows a schematic diagram of an exemplary embodiment for wireless communication.

FIG. 10 shows a schematic diagram of an exemplary embodiment for wireless communication.

FIG. 11 shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for enhancing uplink coverage.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

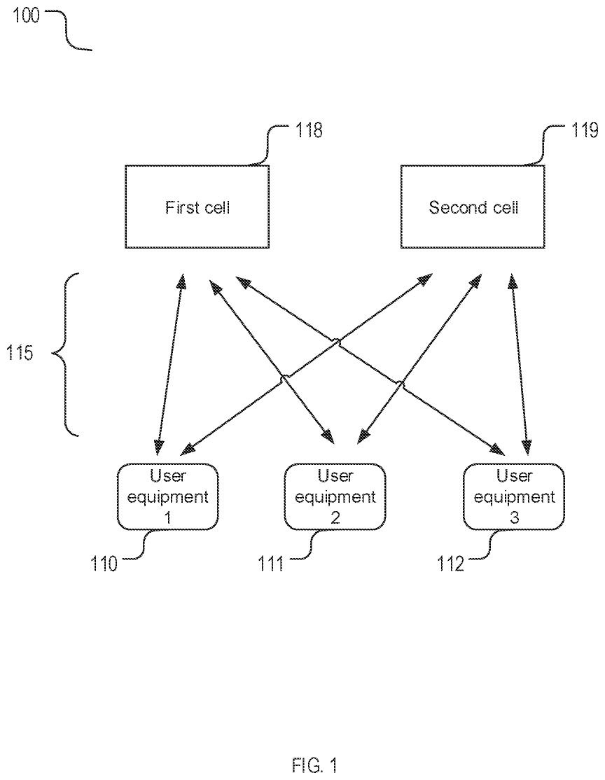

The present disclosure describes various embodiments for enhancing uplink coverage. FIG. 1 shows a wireless communication system 100 including one or more wireless network cell (118 and 119) and one or more user equipment (UE) (110, 111, and 112). The one or more wireless network cells may be associated with one or more wireless network nodes (or base station), respectively.

For the 5th Generation mobile communication technology, a UE 110, for example, a smart phone, may connect to one cell 118, which may be associated with a network node 118, for example, a radio access network (RAN) node and/or a core network (CN) node, or may connect to more than one cells, which may be associated with more than one network nodes (118 and 119), respectively, for example, more than one RAN nodes and/or CN nodes.

The wireless network node (118 and 119) may include a network base station, which may be a nodeB (NB, e.g., a gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time, the first UE 110 may wirelessly communicate with the second network node 119 via a channel including a plurality of radio channels. For another example, the first UE 110 may wirelessly communicate with the first network node 118 and the second network node 119 at the same time.

With the rapid evolution of cellular mobile communication systems, more and more cells will be operate at higher frequencies. For instance, new radio (NR) system may be designed to operate at such as 3.8 GHz on a first frequency range (FR1), and 28 GHz or 39 GHz in a second frequency range (FR2), which is typically much higher than the spectrum used for long term evolution (LTE). For high frequency cells, the wireless channel may be subject to higher path-loss, which results in smaller coverage compared to the cells on lower spectrum. The problem in uplink transmission may be more serious. For a given cell, the uplink coverage may be smaller than the downlink coverage. Thus, when a UE is at a cell edge, initial access procedure may fail due to the shortage of uplink transmission.

To solve the problem of uplink transmission, NR network may configure a supplementary uplink (SUL) carrier for the cell. The SUL operates on a lower frequency, so its coverage and performance may be better than normal uplink (NUL) carrier. So UEs who at cell edge may use SUL carrier for uplink transmission. Although SUL is beneficial for optimizing the uplink coverage, it only works if UE supports the band combination of NUL and SUL carriers. And it also requires operator to use more spectrum resources for deploying two uplink carriers for one cell.

In 5G NR, various embodiments may be implemented to address at least one of the problems/issues discussed above which associate with the uplink transmission problem. Some embodiments may consider some uplink coverage enhancements. In one implementation, physical uplink shared channel (PUSCH) and/or physical uplink control channel (PUCCH) repetition allows UE to send uplink data and control message multiple times, so that network may decode the information based on received repetitions. In another implementation, Msg3 repetition may be considered to solve the random access (RA) problem, and UE may transmit specific random access channel (RACH) preamble to request network to enable Msg3 repetition for this UE.

Some embodiments may provide detailed solution for requesting Msg3 repetition. In some implementations, for UEs who support uplink coverage enhancement and UEs who not support uplink coverage enhancement, the cell coverage may be different, cell selection and reselection configuration may be adjusted for different UEs.

In various embodiments, for an NR cell configured with both NUL and SUL, when RACH is triggered and the carrier (NUL or SUL) to use for RACH procedure is not explicitly configured, the UE may first perform uplink carrier selection based on a configured rsrp-ThresholdSSB-SUL threshold, if the UE supports SUL. If the RSRP of downlink path loss reference is less than the threshold, UE may performs RACH on SUL carrier; if the RSRP of downlink path loss reference is not less than the threshold, UE may perform RACH on NUL carrier. In some implementation, the rsrp-ThresholdSSB-SUL may be per-cell configured.

In various embodiments, in order to inform network the best downlink SSB which may be used to transmit RA response message (i.e., beam refinement), the network may configure RACH resources associated with SSBs, e.g., either different RACH occasion or different RACH preamble associated with different SSBs, so after UE selects a SSB with good RSRP, the UE may select preamble and RACH occasion associated with the SSB, to transmit Msg1. In some implementations, considering UE may locate in the coverage of any downlink SSB, the number of configured RACH resource associated with each SSB may be the same.

In various embodiments, the RACH preamble resource may be grouped as Group A and/or Group B. In some implementation, RACH preamble in Group A may be applicable to small Msg3 transport block size and RACH preamble Group B is applicable to large Msg3 transport block size. In some implementations, for normal RACH configuration, Group A may be mandatory configured, and/or Group B may be optional configured. Here, “large” and/or “small” are relative terms, and may be defined broadly. For example but not limited to, a small block size may refer to ≤48 bits, and/or a large bloc size may be refer to ≥72 bits or ≥96 bits.

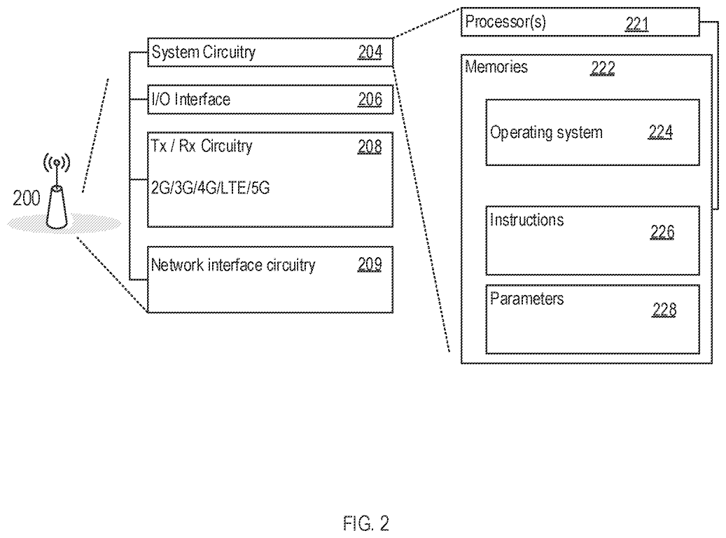

FIG. 2 shows an example of electronic device 200 to implement a network node or network base station, which may provide at least one cell to communicate with one or more UE. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

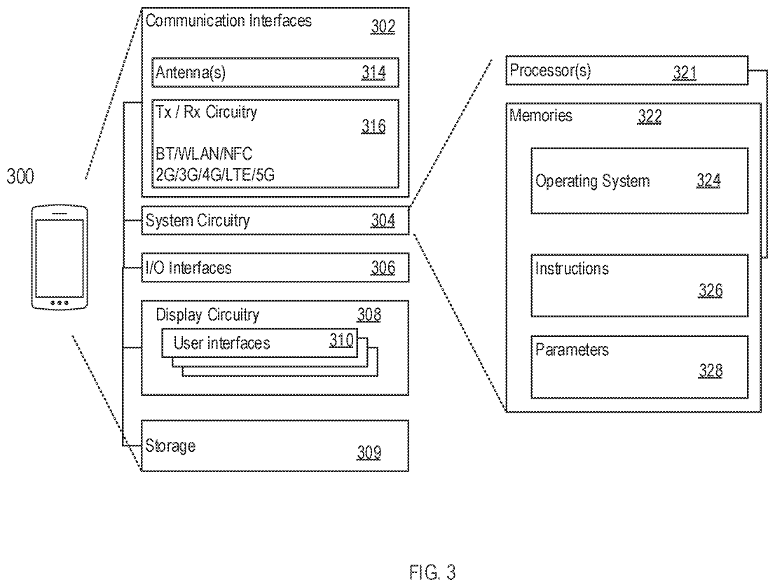

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments, which may be implemented, partly or totally, on the network base station and/or the user equipment described above in FIGS. 2-3.

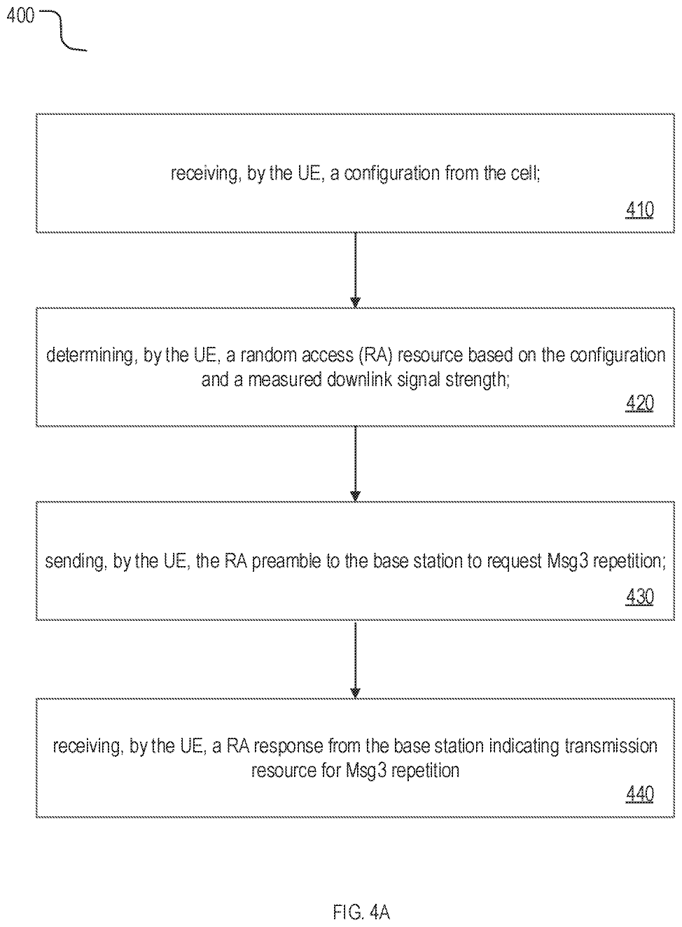

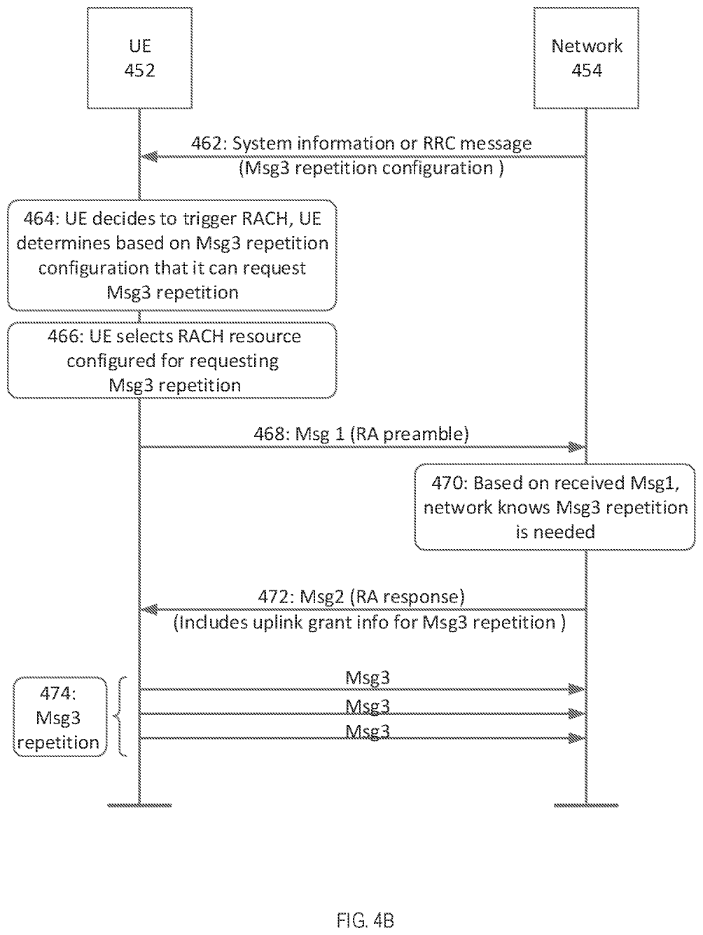

Referring to FIG. 4A, the present disclosure describes embodiments of a method 400 for enhancing, by a user equipment (UE), an uplink coverage of a cell with a base station. The method 400 may include a portion or all of the following steps: step 410: receiving, by the UE, a configuration from the cell; step 420: determining, by the UE, a random access (RA) resource based on the configuration and a measured downlink signal strength; step 430: sending, by the UE, the RA preamble to the base station to request Msg3 repetition; and/or step 440: receiving, by the UE, an RA response from the base station indicating transmission resource for Msg3 repetition.

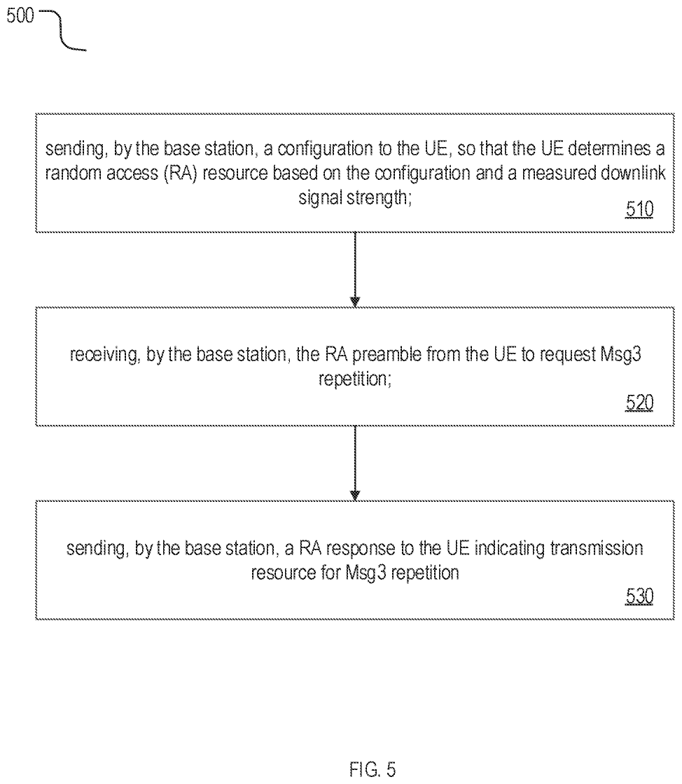

Referring to FIG. 5, the present disclosure describes embodiments of a method 500 for enhancing, by a base station, an uplink coverage of a cell for a user equipment (UE). The method 500 may include a portion or all of the following steps: step 510: sending, by the base station, a configuration to the UE, so that the UE determines a random access (RA) resource based on the configuration and a measured downlink signal strength; step 520: receiving, by the base station, the RA preamble from the UE to request Msg3 repetition; and/or step 530: sending, by the base station, an RA response to the UE indicating transmission resource for Msg3 repetition.

Referring to FIG. 4B, taking Msg3 repetition as an example, a flow diagram may illustrate one or more steps in various embodiments for implementing techniques in network to enables uplink coverage enhancement. A system may include one or more UE 452, and one or more network node 454. The system may perform a portion or all of the steps described in FIG. 4B. In some implementations, the network node may be a NG-eNB, or a gNB. In some other implementations, the network node providing a cell may be a master node (MN) or a secondary node (SN) when dual connectivity is configured. In some other implementations, the network node may be not only limited to 4G, 5G network equipment, but also generally applicable to other wireless communication methods.

Referring to step 462: the network may send an Msg3 repetition configuration to the UE. The Msg3 repetition configuration may be transmitted via system information or at least one radio resource control (RRC) message. Referring to step 464: the UE may decide to trigger RACH, and/or the UE may determine based on the Msg3 repetition configuration that the UE can or may need to request Msg3 repetition. Referring to step 466: the UE may select RACH resource configured for requesting Msg3 repetition. Referring to step 468: the UE may send an Msg1 to the network, and the Msg1 may include a random access (RA) preamble. Referring to step 470: based on the received Msg1, the network may determines whether Msg3 repetition is needed. Referring to step 472, the network may send an Msg2 to the UE, and the Msg2 is RA response. The Msg2 may include uplink grant information (e.g. a number of Msg3 repetitions) for Msg3 repetition. Referring to step 474: upon receiving the Msg2 from the network, the UE may perform Msg3 repetition by repeating sending Msg3 to the network.

Referring to FIG. 4A, in one implementation, the configuration in the method 400 is transmitted in one of system information or at least one radio resource control (RRC) message.

In another implementation, the configuration comprises at least one of the following: a list of synchronization signal block (SSB) indexes, a SSB bitmap, a reference signal received power (RSRP) threshold configuration, a pathloss threshold configuration, or a random access channel (RACH) resource configuration.

In another implementation, the list of SSB indexes indicates that any SSB in the list of SSB indexes is available for the UE to request Msg3 repetition.

In another implementation, the SSB bitmap indicates that any SSB in the SSB bitmap is available for the UE to request Msg3 repetition.

In another implementation, the RSRP threshold configuration comprises at least one of the following: an Msg3 repetition RSRP threshold, an SSB selection RSRP threshold, or a set of two carrier selection RSRP thresholds.

In another implementation, in response to a measured RSRP of a SSB is lower than the Msg3 repetition RSRP threshold, the UE determines to request Msg3 repetition.

Referring to FIG. 4A, in another implementation, the configuration in the method 400 is configured differently for at least one of the following: different uplink carriers comprising a normal uplink (NUL) carrier and a supplementary uplink (SUL) carrier, different bandwidth parts, or different SSBs.

In another implementation, the set of two carrier selection RSRP thresholds comprises a first carrier selection RSRP threshold and a second carrier selection RSRP threshold, the first carrier selection RSRP threshold being applicable to a UE not supporting Msg3 repetition, and the second carrier selection RSRP threshold being applicable to a UE supporting Msg3 repetition.

In another implementation, in response to the UE not supporting Msg3 repetition and a measured RSRP of a downlink pathloss reference being lower than the first carrier selection RSRP threshold, the UE determines to select a supplementary uplink (SUL) carrier of the cell to perform RACH; in response to the UE not supporting Msg3 repetition and the measured RSRP of the downlink pathloss reference being higher than or equal to the first carrier selection RSRP threshold, the UE determines to select a normal uplink (NUL) carrier of the cell to perform RACH; in response to the UE supporting Msg3 repetition and the measured RSRP of the downlink pathloss reference being lower than the second carrier selection RSRP threshold, the UE determines to select the SUL carrier of the cell to perform RACH; and in response to the UE supporting Msg3 repetition and the measured RSRP of the downlink pathloss reference being higher than or equal to the second carrier selection RSRP threshold, the UE determines to select the NUL carrier of the cell to perform RACH.

In another implementation, the RACH resource configuration comprises at least one of the following: a RACH occasion associated with a SSB; at least one random access preamble associated with a SSB; at least one preamble for RACH group A; or at least one preamble for RACH group B.

In another implementation, the RACH resource configuration comprises at least one of the following parameters for triggering RACH with Msg3 repetition: a preambleTransMax; a preambleReceivedTargetPower; a powerRampingStep; a ra-ResponseWindow; or an Msg3-DeltaPreamble.

In various embodiments, the UE receives Msg3 repetition configuration from the network. The configuration includes one or more of the following: a list of SSB indexes or a SSB bitmap, used by the UE to determine in which area Msg3 repetition can be requested; an RSRP threshold configuration or a pathloss threshold configuration, which is used by the UE to determine in which conditions Msg3 repetition can be requested; and/or a RACH resource configuration, which is used by the UE to request Msg3 repetition.

The list of SSB indexes or SSB bitmap, when it is received by the UE, may mean only if the UE is within the coverage of these SSBs, and the UE can request network to trigger Msg3 repetition when other conditions (e.g., RSRP threshold) are fulfilled.

Optionally, when the list of SSB indexes is not received, it may mean that no matter whether the UE is within the coverage of which SSB, the UE can request network to trigger Msg3 repetition when other conditions (e.g., RSRP threshold) are fulfilled.

Optionally, the list of SSB indexes can be explicitly configured by network, or it can be implicitly indicated by a SSB mask index, and the mapping relation between “SSB mask index” and “SSB indexes” may be pre-configured in specification.

In various embodiments, an RSRP threshold configuration may include one or more of the following:

(1) Msg3 repetition RSRP threshold. If a measured RSRP of an SSB or RSRP of pathloss reference is lower than this threshold, the UE can request network to enable Msg3 repetition. The threshold can be configured differently for different carriers (NUL or SUL), and/or for different BWPs, and/or for different SSBs.

(2) Normal SSB selection RSRP threshold (e.g., rsrp-ThresholdSSB), which is used by the UE to determine which SSB can be selected to perform RACH procedure. The threshold can be configured differently for different carriers (NUL or SUL), and/or for different BWPs.

(3) Two carrier selection RSRP thresholds, which are used by the UE to determine whether to select NUL or SUL to perform random access. If the RSRP of downlink pathloss reference is lower than the threshold, UE should select SUL to perform RACH, otherwise, UE can select NUL to perform RACH. Wherein, one threshold is only applicable to UEs does not support Msg3 repetition, and the other threshold is only applicable to UEs supporting Msg3 repetition.

In various embodiments, for pathloss threshold configuration (e.g., rsrp-Threshold), the UE determines whether the measured pathloss result is lower than the threshold or lower than a calculation based on the threshold (e.g., PCMAX (of the Serving Cell performing the Random Access Procedure)-preambleReceivedTargetPower-msg3-DeltaPreamble-rsrp-Pathloss).

In various embodiments, a RACH resource configuration may includes RACH occasion and random access preambles associated with SSBs. When the UE evaluates and determines that Msg3 repetition is needed for the selected SSB, the UE can use the RA preamble associated with this SSB to trigger random access, and RA preamble may be sent on corresponding RACH occasion.

Optionally, the RACH resources can include preambles for only Group A or only Group B, or both Group A and Group B. In one implementation, Group A may refer to small block size of Msg3 and Group B may refer to big block size of Msg3, for example but not limited to, Group A may include preambles that used to inform network size of Msg3 is equal to or smaller than 48 bits, and Group B may include preambles that used to inform network that the size of Msg3 is about 72 bits and/or 96 bits. In another implementation, there may be about 40 preambles for Group A and about 24 preambles for Group B.

Optionally, the RACH resource configuration for Msg3 repetition may also include one or more of following parameters, which are applicable when UE decides to trigger RACH with Msg3 repetition: a preambleTransMax; a preambleReceivedTargetPower; a powerRampingStep; a ra-ResponseWindow; an Msg3-DeltaPreamble.

In other implementation, when the UE fallbacks from “RACH with Msg3 repetition” to “normal RACH procedure (without Msg3 repetition)”, the UE may switch to the RACH parameters associated with normal RACH procedure, or the UE may need to maintain the value of RACH parameter configured for Msg3 repetition, or one or more different methods may be taken for different RACH parameters.

In other implementation, when the UE fallbacks from “normal RACH procedure (without Msg3 repetition)” to “RACH with Msg3 repetition”, UE may switch to the RACH parameters associated with Msg3 repetition, or the UE may maintain the value of RACH parameter configured for normal RACH procedure, or one or more different methods may be taken for different RACH parameters.

Optionally, the Msg3 repetition configuration can be carried in system information, or RRC messages.

Optionally, different Msg3 repetition configurations can be configured for different type of UEs (e.g., RedCap and Normal UE), and for UE from different slices.

The method and/or technique described in any of the above embodiments is applicable to any kind of RACH procedures, for example but not limited to, initial access, handover, beam failure recovery, and any other RACH procedure.

Optionally in some embodiments, when RACH procedure is triggered via PDCCH order, the network may directly indicate the UE whether to perform Msg3 repetition; the UE may follow the network's indication without evaluating the RSRP threshold. In one implementation, the indication may be carried by RRC signalling or DCI for PDCCH order.

Optionally in some embodiments, for RACH resource configuration, the network may provide multiple RACH resources pools, wherein each resource pool includes RACH occasions and/or RACH preamble resources. For each configured RACH resource pool, network can indicate this RACH resource pool is applicable to which UE type (e.g., RedCap UE, non-RedCap UE), and/or to which slice, and/or to which feature (e.g., Msg3 repetition, small data transmission).

Referring to FIG. 4A, the method 400 may, optionally and/or alternatively, include selecting, by the UE, a SSB during a RACH initiation based on the SSB selection RSRP threshold and the Msg3 repetition RSRP threshold by selecting the SSB based on the SSB selection RSRP threshold, and determining whether to perform Msg3 repetition based on the Msg3 repetition RSRP threshold. In one implementation, in response to a measured RSRP of the SSB being higher than the SSB selection RSRP threshold and the measured RSRP of the SSB being lower than the Msg3 repetition RSRP threshold, the UE selects the SSB and triggers Msg3 repetition; in response to the measured RSRP of the SSB being higher than the SSB selection RSRP threshold and the measured RSRP of the SSB being higher than the Msg3 repetition RSRP threshold, the UE selects the SSB without triggering Msg3 repetition, and in response to measured RSRP of all SSBs being lower than or equal to the SSB selection RSRP threshold and the measured RSRP of a SSB being lower than the Msg3 repetition RSRP threshold, the UE selects the SSB and triggers Msg3 repetition.

In various embodiments, for SSB selection during RACH initiation, there may be three alternative solutions.

### Solution 1: Two-Step Approach

The UE first selects SSB based on “Normal SSB selection RSRP threshold”, then UE determines whether Msg3 repetition is needed based on “Msg3 repetition RSRP threshold”.

In one implementation, when a SSB's RSRP is above “Normal SSB selection RSRP threshold”, and when the SSB's RSRP is lower than “Msg3 repetition RSRP threshold”, the UE selects the SSB and triggers Msg3 repetition.

In another implementation, when a SSB's RSRP is above “Normal SSB selection RSRP threshold”, and when the SSB's RSRP is above “Msg3 repetition RSRP threshold”, the UE selects the SSB without triggering Msg3 repetition.

In another implementation, when no SSB's RSRP is above “Normal SSB selection RSRP threshold”, and when the RSRP of a SSB is lower than “Msg3 repetition RSRP threshold”, the UE selects the SSB and triggers Msg3 repetition.

### Solution 2: One-Step Approach

The UE selects SSB and determines whether Msg3 repetition is needed directly based on the “Msg3 repetition RSRP threshold”. In one implementation, when a SSB with highest RSRP is lower than the threshold, the UE selects the SSB and triggers Msg3 repetition.

### Solution 3: One-Step Approach

The UE selects SSB and determines whether Msg3 repetition is needed directly based on the “Normal SSB selection RSRP threshold”. In one implementation, when no SSB's RSRP is above the threshold, the UE selects any SSB and triggers Msg3 repetition.

In one or more implementations described above, the SSB that is selected may be any SSB randomly selected from one or more SSBs satisfying the corresponding conditions, or may be a SSB with strongest signal strength among one or more SSBs satisfying the corresponding conditions, or may be a SSB with a first measured signal strength satisfying the corresponding conditions.

One example is describes below, which may be applicable to any embodiment or a combination of more than one embodiments discussed above.

An NR cell is configured with only NUL (SUL is not configured). The cell is transmitting 8 downlink (DL) SSBs, from index 0 to index 7. The cell has enabled Msg3 repetition, and the Msg3 repetition configuration is broadcasted in system information. The configuration includes the following:
1. A list of SSB indexes, includes SSB-1, SSB-3 and SSB-5, or a bitmap with the bits corresponding to SSB-1, SSB-3 and SSB-5 set to 1.
2. An Msg3 repetition RSRP threshold=−100 dBm, applicable to all SSBs of the NUL.
3. An SSB selection RSRP threshold=−90 dBm, applicable to all SSBs of the NUL.
4. Msg3 repetition RACH resources associated with SSB-1, SSB-3 and SSB-5, including: a) Number of preambles per SSB; and its value=5; and b) Number of SSBs per RACH occasion, and its value=3.

UE-1 is camping on this NR cell, and UE-1 supports Msg3 repetition. UE-1 initiates RACH procedure to access the NR cell. UE-1 measures the DL SSB of cell, and finds the best SSB is SSB-0, whose RSRP is −105 dBm. Considering there is no SSB whose RSRP is above the SSB selection RSRP threshold, so UE continues to evaluate Msg3 repetition RSRP threshold. Although the RSRP of SSB-0 is below the configured threshold (−100 dBm), the SSB-0 is not listed in the configured SSB list. So UE-1 cannot trigger Msg3 repetition. In this case, UE-1 triggers RACH with an RA preamble which is not belonging to the configured Msg3 repetition RACH resources.

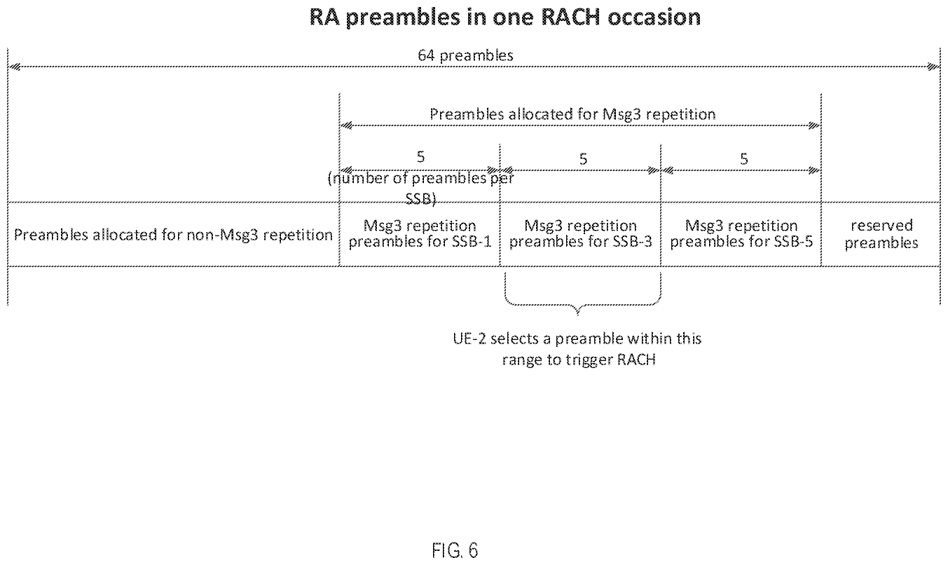

UE-2 is camping on this NR cell, the UE-2 also supports Msg3 repetition. UE-2 initiates RACH procedure to access the NR cell. UE-2 measures the DL SSB of cell, and finds the best SSB is SSB-3, whose RSRP is −106 dBm. Considering there is no SSB whose RSRP is above the SSB selection RSRP threshold, so UE continues to evaluate Msg3 repetition RSRP threshold. The RSRP of SSB-3 is below the configured threshold (−100 dBm), the SSB-3 is listed in the configured SSB list. So UE-2 can trigger Msg3 repetition. In this case, UE triggers RACH with an RA preamble which is belonging to the configured Msg3 repetition RACH resources. After receiving the RA preamble, network knows Msg3 repetition is needed, and network sends RA response message to UE, and indicates the UL transmission resource for Msg3 repetition. More specifically, the selected RA preamble is within a specific range, as shown in FIG. 6.

Another example is describes below, which may be applicable to any embodiment or a combination of more than one embodiments discussed above.

A NR cell is configured with only NUL (SUL is not configured). The cell is transmitting 8 DL SSBs, from index 0 to index 7. The cell has enabled Msg3 repetition, and the Msg3 repetition configuration is broadcasted in system information. The configuration includes the following:

### 1. An SSB Mask Index.

The mapping relation between SSB mask index and SSB indexes are pre-defined in specification. For example, Table 1 shows an example of the mapping relation.

TABLE 1
Mapping relation between SSB mask index and SSB indexes

| SSB Mask Index | Associated SSB indexes |
|---|---|
| 0 | All |
| 1 | Every even SSB index |
| 2 | Every odd SSB index |
| 3 | SSB index 0~3 |
| 4 | SSB index 4~7 |
| 5 | reserved |
| 6 | reserved |
| 7 | reserved |

The SSB mask index is set to 2, which means SSB-1, SSB-3, SSB-5 and SSB-7 are allowed to trigger Msg3 repetition.

2. An Msg3 repetition RSRP threshold=−100 dBm, applicable to all SSBs of the NUL.

3. Msg3 repetition RACH resources associated with SSB-1, SSB-3, SSB-5, and SSB-7, including: a) Number of preambles per SSB, and its value=5; b) Number of SSBs per RACH occasion, and its value=3; c) Number of RA preambles group A, and its value=0, which implies only UE who intends to send Msg3 with large message size can trigger Msg3 repetition.

UE-1 is camping on this NR cell, and UE-1 supports Msg3 repetition. UE-1 initiates RACH procedure to access the NR cell. And UE-1 intends to send Msg3 with smaller Msg3 transport block size (which means UE should select RA preamble Group A).

UE-1 measures the DL SSB of cell, and finds the best SSB is SSB-1, whose RSRP is −105 dBm. Although the RSRP of SSB-1 is below the configured threshold (−100 dBm), and the SSB-1 is listed in the allowed SSB list. But RACH resources for Msg3 repetition only provides Group B preambles. So UE-1 cannot trigger Msg3 repetition. In this case, UE-1 triggers RACH with an RA preamble which is not belonging to the configured Msg3 repetition RACH resources.

UE-2 is camping on this NR cell, the UE-2 also supports Msg3 repetition. UE-2 initiates RACH procedure to access the NR cell. And UE-2 intends to send Msg3 with large Msg3 transport block size (which means UE should select RA preamble Group B).

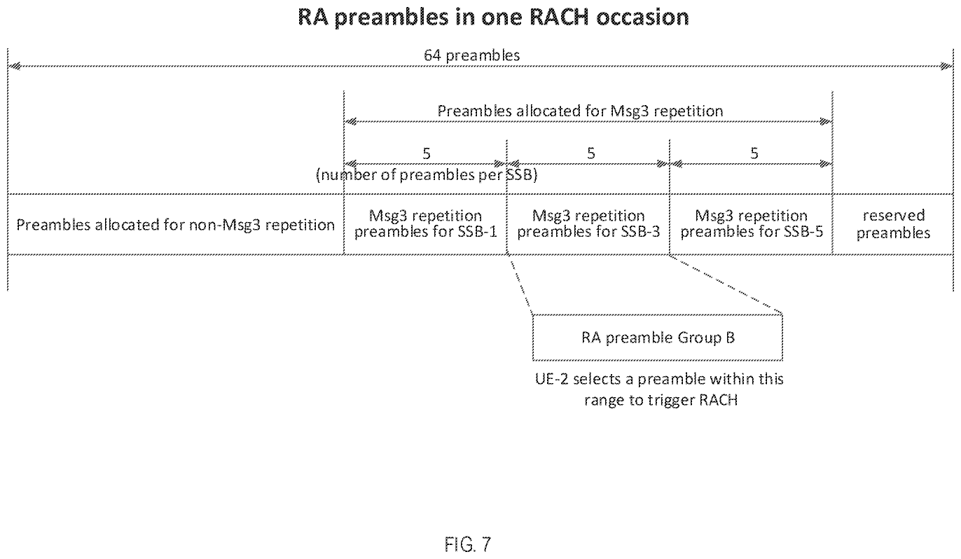

UE-2 measures the DL SSB of cell, and finds the best SSB is SSB-3, whose RSRP is −106 dBm. The RSRP of SSB-3 is below the configured threshold (−100 dBm), and SSB-3 is listed in the allowed SSB list. Meanwhile, the RACH resource has provide Group B preambles for requesting Msg3 repetition. So UE-2 can trigger Msg3 repetition. In this case, UE triggers RACH with an RA preamble which is belonging to the configured Msg3 repetition RACH resources. After receiving the RA preamble, network knows Msg3 repetition is needed, and network sends RA response message to UE-2, and indicates the UL transmission resource for Msg3 repetition. More specifically, the selected RA preamble is within a specific range, as shown in FIG. 7.

Another example is describes below, which may be applicable to any embodiment or a combination of more than one embodiments discussed above.

A NR cell is configured with both NUL and SUL. The cell is transmitting 8 SSBs in downlink, from index 0 to index 7. The cell has enabled Msg3 repetition on NUL, but does not enable Msg3 repetition on SUL. So network provides the Msg3 repetition configuration included in NUL configuration, and is broadcasted in system information. The Msg3 repetition configuration includes the following:

1. An Msg3 repetition RSRP threshold=−100 dBm, applicable to all SSBs of the NUL.

2. Two carrier selection RSRP threshold: a) Threshold-1=−100 dBm, applicable to UEs not supporting Msg3 repetition; and b) Threshold-2=−115 dBm, applicable to UEs supporting Msg3 repetition.

3. Msg3 repetition RACH resources associated with all SSBs, including: a) Number of preambles per SSB, and its value=5; b) Number of SSBs per RACH occasion, and its value=1; c) Number of RA preambles group A, and its value=2.

No SSB index list is provided, which means Msg3 repetition can be triggered to all SSBs.

UE-1 is camping on this NR cell, and UE-1 does not support Msg3 repetition. UE-1 initiates RACH procedure to access the NR cell. UE-1 measures the RSRP of downlink pathloss reference, the result is −105 dBm. Considering UE-1 does not support Msg3 repetition, so based on carrier selection Threshold-1, UE-1 should select SUL to perform RACH. And UE-1 triggers RACH with an RA preamble which is not belonging to the configured Msg3 repetition RACH resources.

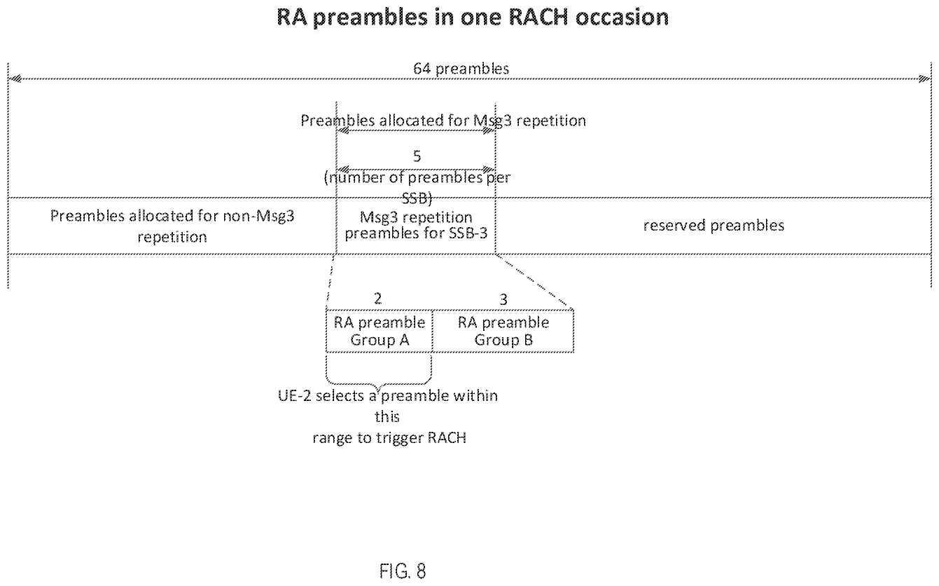

UE-2 is camping on this NR cell, the UE-2 supports Msg3 repetition. UE-2 initiates RACH procedure to access the NR cell. UE-2 measures the RSRP of downlink pathloss reference, the result is also −105 dBm. Considering UE-2 supports Msg3 repetition, so based on carrier selection Threshold-2, UE-2 should select NUL to perform RACH. Moreover, UE measures the RSRP of SSBs, the highest RSRP of SSB-3 is −110, the results is lower than the Msg3 repetition RSRP threshold on NUL, so UE-2 can trigger Msg3 repetition. In addition, UE-2 intends to send Msg3 with small Msg3 transport block size (which means UE should select RA preamble Group A). After receiving the RA preamble, network knows Msg3 repetition is needed, and network sends RA response message to UE-2, and indicates the UL transmission resource for Msg3 repetition. More specifically, the selected RA preamble is within a specific range, as shown in FIG. 8.

Another example is describes below, which may be applicable to any embodiment or a combination of more than one embodiments discussed above.

A NR cell is configured with both NUL and SUL. The cell is transmitting 8 SSBs in downlink, from index 0 to index 7. The cell has enabled Msg3 repetition on both NUL and SUL. So network provides the Msg3 repetition configuration in both NUL and SUL configuration, and is broadcasted in system information.

The Msg3 repetition configuration of NUL includes the following:

1. An Msg3 repetition RSRP threshold=−100 dBm, applicable to all SSBs of the NUL.

2. Msg3 repetition RACH resources associated with all SSBs, including: a) Number of preambles per SSB, and its value=5; b) Number of SSBs per RACH occasion, and its value=3; c) Number of RA preambles group A, and its value=2.

No SSB index list is provided, which means Msg3 repetition can be triggered to all SSBs on NUL.

The Msg3 repetition configuration of SUL includes the following:

1. A list of SSB indexes, includes SSB-1, SSB-3 and SSB-5, or a bitmap with the bits corresponding to SSB-1, SSB-3 and SSB-5 set to 1.

2. An Msg3 repetition RSRP threshold=−115 dBm, applicable to all SSBs of the NUL.

3. Msg3 repetition RACH resources associated with SSB-1, SSB-3 and SSB-5, including: a) Number of preambles per SSB, and its value=5; b) Number of SSBs per RACH occasion, and its value=1; c) Number of RA preambles group A, and its value=0, which implies only UE who intends to send Msg3 with large message size on SUL can trigger Msg3 repetition.

In addition, network configures two carrier selection RSRP thresholds:

1. Threshold-1=−100 dBm, applicable to UEs not supporting Msg3 repetition.

2. Threshold-2=−110 dBm, applicable to UEs supporting Msg3 repetition.

UE-1 is camping on this NR cell, and UE-1 supports Msg3 repetition. UE-1 initiates RACH procedure to access the NR cell. UE-1 measures the RSRP of downlink pathloss reference, the RSRP result is −105 dBm. Considering UE-1 supports Msg3 repetition, so based on carrier selection Threshold-2, UE-1 should select NUL to perform RACH.

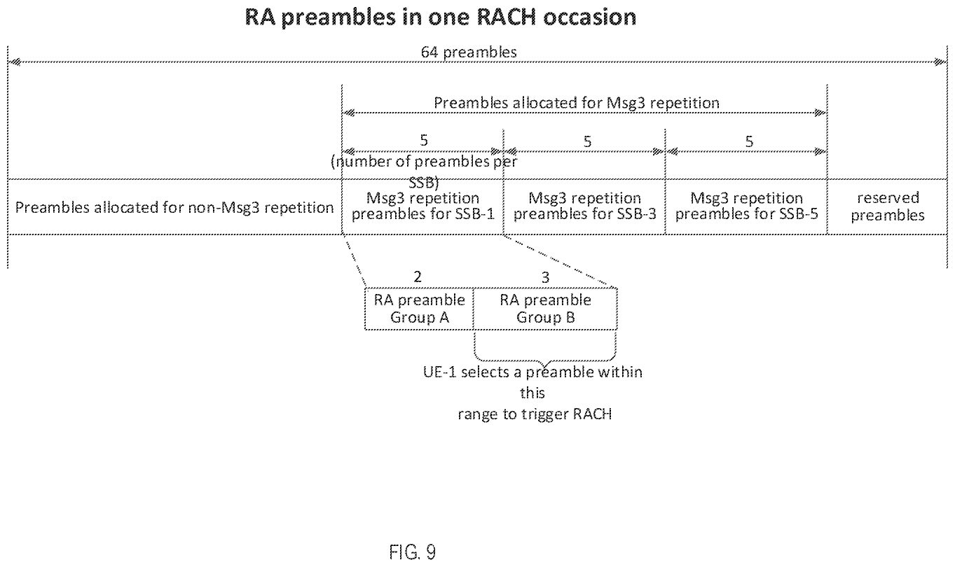

UE-1 measures the RSRP of SSBs, and finds the best SSB is SSB-1, the RSRP result is −110 dBm. Based on the Msg3 repetition configuration configured for NUL, the RSRP result of SSB-1 is lower than the Msg3 repetition RSRP threshold, so UE-1 can trigger Msg3 repetition. UE-1 intends to send Msg3 with large Msg3 transport block size (which means UE should select RA preamble Group B). After receiving the RA preamble, network knows Msg3 repetition is needed, and network sends RA response message to UE-1, and indicates the UL transmission resource for Msg3 repetition. More specifically, the selected RA preamble is with a specific range, as shown in FIG. 9.

UE-2 is camping on this NR cell, the UE-2 supports Msg3 repetition. UE-2 initiates RACH procedure to access the NR cell. UE-2 measures the RSRP of downlink pathloss reference, the RSRP is −117 dBm. Considering UE-2 supports Msg3 repetition, so based on carrier selection Threshold-2, UE-2 should select SUL to perform RACH. Moreover, the UE measures the RSRP of SSBs, and finds the best SSB is SSB-3, the RSRP result is −118 dBm, which is lower than the Msg3 repetition RSRP threshold on SUL. However, UE-2 intends to send Msg3 with small Msg3 transport block size (which means UE should select RA preamble Group A). But SUL only configured Msg3 repetition RACH resources for Group B, so UE-2 cannot trigger Msg3 repetition. In this case, UE-2 RACH with an RA preamble which is not belonging to the configured SUL Msg3 repetition RACH resources.

Another example is describes below, which may be applicable to any embodiment or a combination of more than one embodiments discussed above.

A NR cell is configured with only NUL (SUL is not configured). The cell is transmitting 8 DL SSBs, from index 0 to index 7. The cell has enabled Msg3 repetition, and the Msg3 repetition configuration is sent to UE via RRC message. The configuration includes the following:

1. Different Msg3 repetition RSRP thresholds associated with different SSB indexes, including:
a) Threshold-Msg3Repetition1=−120 dBm for SSB-0;
b) Threshold-Msg3Repetition2=−100 dBm for SSB-1;
c) Threshold-Msg3Repetition3=−110 dBm for SSB-2;
d) . . .

2. Msg3 repetition RACH resources associated with all SSBs, including: a) Number of preambles per SSB, and its value=5; b) Number of SSBs per RACH occasion, and its value=1,

UE-1 supports Msg3 repetition is connected to this NR cell, UE-1 initiates RACH procedure due to beam failure recovery. UE-1 measures the DL SSB of cell, and finds the best SSB is SSB-0, whose RSRP is −105 dBm. Because the RSRP result of SSB-0 is higher than the Msg3 repetition RSRP threshold configured for SSB-0, so Msg3 repetition is not needed. In this case, UE-1 triggers RACH with an RA preamble which is not belonging to the configured Msg3 repetition RACH resources. After receiving the preamble, network knows Msg3 repetition is not needed, and network sends RA response message to UE-1, without including the UL transmission resource for Msg3 repetition.

UE-2 supports Msg3 repetition is connected to this NR cell, UE-2 initiates RACH procedure due to intra-cell handover. UE-2 measures the DL SSB of cell, and finds the best SSB is SSB-1, whose RSRP is −105 dBm. Because the RSRP result of SSB-1 is lower than the Msg3 repetition RSRP threshold configured for SSB-1, so UE-2 can trigger Msg3 repetition. In this case, UE-2 triggers RACH with an RA preamble which is belonging to the configured Msg3 repetition RACH resources. After receiving the preamble, network knows Msg3 repetition is needed, and network sends RA response message to UE-2, including the UL transmission resource for Msg3 repetition.

UE-3 supports Msg3 repetition is connected to this NR cell, UE-3 initiates RACH procedure due to SI request. UE-3 measures the DL SSB of cell, and finds the best SSB is SSB-2, whose RSRP is −115 dBm. Because the RSRP result of SSB-2 is lower than the Msg3 repetition RSRP threshold configured for SSB-2, so UE-3 can trigger Msg3 repetition. In this case, UE-3 triggers RACH with an RA preamble which is belonging to the configured Msg3 repetition RACH resources. After receiving the preamble, network knows Msg3 repetition is needed, and network sends RA response message to UE-3, including the UL transmission resource for Msg3 repetition.

Referring to FIG. 4A, the method 400 may, optionally and/or alternatively, include performing, by the UE, cell selection and reselection based on at least one access threshold, the at least one access threshold being configured by the base station via system information.

In one implementation, the at least one access threshold comprises at least one of the following: a first threshold being applicable to a UE not supporting SUL and Msg3 repetition; a second threshold being applicable to a UE supporting Msg3 repetition and not supporting SUL; a third threshold being applicable to a UE supporting SUL and not supporting Msg3 repetition; or a fourth threshold being applicable to a UE supporting SUL and Msg3 repetition. In another implementation, each of the at least one access threshold is provided by one of an absolute value or a relative offset.

In another implementation, the fourth threshold is applicable for at least one of the following: at an individual cell level, or at an individual frequency level.

In various embodiments, for cell selection and cell reselection, the network configures one or more of minimum access thresholds (e.g., q-RxLevMin) in system information, including: Threshold-1: applicable to UEs that does not supporting SUL and Msg3 repetition; Threshold-2: applicable to UEs that support Msg3 repetition without supporting SUL (or SUL is not configured for the cell); Threshold-3: applicable to UEs that support SUL without supporting Msg3 repetition; and Threshold-4: applicable to UEs that supporting both SUL and Msg3 repetition when SUL carrier is configured for the cell.

Optionally, the minimum access thresholds can be provided by absolute values. Or provided by relative offset. Or partial are provided by absolute value, partial are provide by relative offset.

Optionally, the minimum access thresholds are configured for different measure quantities, for example but not limited to, RSRP, RSRQ, or signal to interference and noise ratio (SINR).

Optionally, for each neighbour cell, the network can configure a per-cell level indication in system information, indicates whether the related neighbour cell should apply the minimum access threshold which is configured for UEs that supporting both SUL and Msg3 repetition.

Optionally, for each inter frequency, the network can configure a per-frequency level indication in system information, indicates whether the related frequency should apply the minimum access threshold which is configured for UEs that supporting both SUL and Msg3 repetition.

Optionally, different network nodes can exchange their supporting capability of Msg3 repetition, in order to update the minimum access thresholds for cell selection to neighbour cell/frequency. The network capability can be exchanged via X2 or Xn interface.

One example is describes below, which may be applicable to any embodiment or a combination of more than one embodiments discussed above.

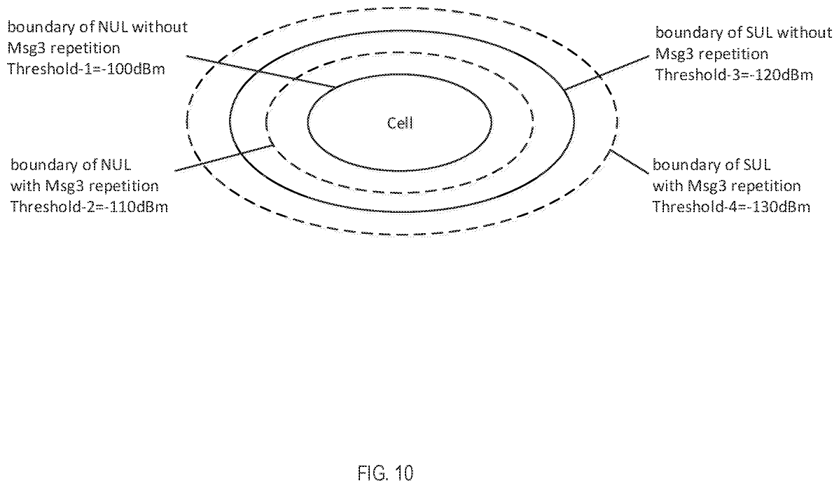

A NR cell is configured with both NUL and SUL, and the cell has enabled Msg3 repetition on both NUL and SUL carriers. For cell selection, following thresholds are configured in SIB1, as shown in FIG. 10.

Threshold-1=−100 dBm: applicable to UEs that does not supporting SUL and Msg3 repetition.

Threshold-2=−110 dBm: applicable to UEs that support Msg3 repetition without supporting SUL (or SUL is not configured for the cell).

Threshold-3=−120 dBm: applicable to UEs that support SUL without supporting Msg3 repetition.

Threshold-4=−130 dBm: applicable to UEs that supporting both SUL and Msg3 repetition when SUL carrier is configured for the cell.

UE-1 does not support SUL and Msg3 repetition, UE-1 intends to camp on this NR cell, it measures the RSRP of cell, and the RSRP result is −106 dBm. Considering the UE does not support SUL and Msg3 repetition, so UE uses Threshold-1 to calculate S value, and finds Srxlev<0, so UE cannot camp on this NR cell. The Srxlev may refer to Cell selection RX level value (in dB) measured by UE.

UE-2 does not support SUL, but it supports Msg3 repetition, UE-2 intends to camp on this NR cell, it measures the RSRP of cell, and the RSRP result is −106 dBm. Considering the UE does not support SUL but Msg3 repetition, so UE uses Threshold-2 to calculate S value, and finds Srxlev>0, so UE can camp on this NR cell.

UE-3 supports SUL, but it does not support Msg3 repetition, UE-3 intends to camp on this NR cell, it measures the RSRP of cell, and the RSRP result is −122 dBm. Considering the UE supports SUL but does not support Msg3 repetition, so UE uses Threshold-3 to calculate S value, and finds Srxlev<0, so UE cannot camp on this NR cell.

UE-4 supports both SUL and Msg3 repetition, UE-4 intends to camp on this NR cell, it measures the RSRP of cell, and the RSRP result is −122 dBm. Considering the UE supports both SUL and Msg3 repetition, so UE uses Threshold-4 to calculate S value, and finds Srxlev>0, so UE cannot camp on this NR cell.

Another example is describes below, which may be applicable to any embodiment or a combination of more than one embodiments discussed above.

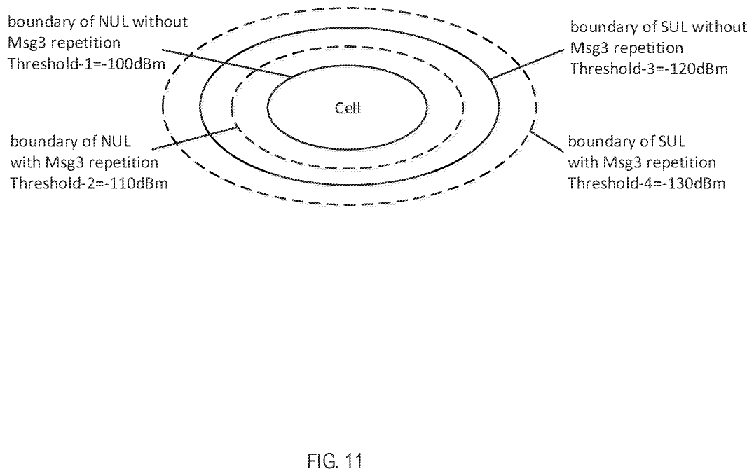

A NR cell is configured with both NUL and SUL, and the cell has enabled Msg3 repetition on both NUL and SUL carriers. For cell selection, following thresholds are configured in SIB1, as shown in FIG. 11.

Threshold-1=−100 dBm: applicable to UEs that does not supporting SUL and Msg3 repetition.

Threshold-2=−10 dB offset to Threshold-1: applicable to UEs that support Msg3 repetition without supporting SUL (or SUL is not configured for the cell).

Threshold-3=−120 dBm: applicable to UEs that support SUL without supporting Msg3 repetition.

Threshold-4=−10 dB offset to Threshold-3: applicable to UEs that supporting both SUL and Msg3 repetition when SUL carrier is configured for the cell.

UE-1 does not support SUL and Msg3 repetition, UE-1 intends to camp on this NR cell, it measures the RSRP of cell, and the RSRP result is −106 dBm. Considering the UE does not support SUL and Msg3 repetition, so UE uses Threshold-1 to calculate S value, and finds Srxlev<0, so UE cannot camp on this NR cell.

UE-2 does not support SUL, but it supports Msg3 repetition, UE-2 intends to camp on this NR cell, it measures the RSRP of cell, and the RSRP result is −106 dBm. Considering the UE does not support SUL but Msg3 repetition, so UE uses Threshold-2 to calculate S value, and finds Srxlev>0, so UE can camp on this NR cell.

UE-3 supports SUL, but it does not support Msg3 repetition, UE-3 intends to camp on this NR cell, it measures the RSRP of cell, and the RSRP result is −122 dBm. Considering the UE supports SUL but does not support Msg3 repetition, so UE uses Threshold-3 to calculate S value, and finds Srxlev<0, so UE cannot camp on this NR cell.

UE-4 supports both SUL and Msg3 repetition, UE-4 intends to camp on this NR cell, it measures the RSRP of cell, and the RSRP result is −122 dBm. Considering the UE supports both SUL and Msg3 repetition, so UE uses Threshold-4 to calculate S value, and finds Srxlev>0, so UE can camp on this NR cell.

Another example is describes below, which may be applicable to any embodiment or a combination of more than one embodiments discussed above.

An NR cell-0 has multiple neighbour cells on different frequencies.

Cell-1, Cell-2, Cell-3 on inter frequency “freq1”, wherein Cell-1 supports Msg3 repetition, and Cell-2, Cell-3 do not support Msg3 repetition.

Cell-4, Cell-5, Cell-6 on inter frequency “freq2”, wherein Cell-4 does not support Msg3 repetition, and Cell-5, Cell-6 support Msg3 repetition.

Cell-7, Cell-8, Cell-9 on inter frequency “freq3”, wherein all cells on freq3 support Msg3 repetition.

For cell reselection, Cell-1 configures following minimum access thresholds for frequencies in its system information (e.g., SIB 4).

1. For freq1:

a) Threshold-1=−100 dBm, Threshold-1a=−110 dBm, wherein Threshold-1 is applicable to UE or cell not supporting Msg3 repetition; and Threshold-1a is applicable to UE and cell supporting Msg3 repetition.

b) A list of freq1 cell indexes and Msg3 repetition indication associated with each cell. For Cell-1, the indication is set to “True”; for Cell-2 and Cell-3, the indications are set to “FALSE”.

2. For freq2:

a) Threshold-2=−105 dBm, Threshold-2a=−115 dBm, wherein Threshold-2 is applicable to UE or cell not supporting Msg3 repetition, and Threshold-2a is applicable to UE and cell supporting Msg3 repetition.

b) A list of freq2 cell indexes and Msg3 repetition indication associated with each cell. For Cell-4 the indication is set to “FALSE”; for Cell-5 and Cell-6, the indications are set to “TRUE”.

3. For freq3:

a) Threshold-3=−105 dBm, Threshold-3a=−120 dBm, wherein Threshold-3 is applicable to UE or cell not supporting Msg3 repetition, and Threshold-3a is applicable to UE and cell supporting Msg3 repetition.

b) Msg3 repetition indication associated with freq3. The indications are set to “TRUE”, which means all cells on freq3 support Msg3 repetition.

UE-1 is camp on Cell-0, and it does not support Msg3 repetition, UE-1 intends to reselect to Cell-1 on freq1. It measures the RSRP of Cell-1 and the RSRP result is −106 dBm. Considering the UE does not support Msg3 repetition, so UE uses Threshold-1 to calculate S value, and finds Srxlev<0, so UE cannot reselect to Cell-1.

UE-2 is camp on Cell-0, and it supports Msg3 repetition, UE-2 intends to reselect to Cell-1 on freq1. It measures the RSRP of Cell-1 and the RSRP result is −106 dBm. Considering the UE supports Msg3 repetition, so UE uses Threshold-1a to calculate S value, and finds Srxlev>0, so UE can reselect to Cell-1.

UE-3 is camp on Cell-0, and it supports Msg3 repetition, UE-3 intends to reselect to Cell-4 on freq2. It measures the RSRP of Cell-4 and the RSRP result is −110 dBm. However, although the UE supports Msg3 repetition, but the Msg3 repetition indication of Cell-4 indicates that Msg3 repetition is not supported on Cell-4. So UE uses Threshold-2 to calculate S value, and finds Srxlev<0, so UE cannot reselect to Cell-4.

UE-4 is camp on Cell-0, and it supports Msg3 repetition, UE-4 intends to reselect to Cell-8 on freq3. It measures the RSRP of Cell-8 and the RSRP result is −110 dBm. Considering the UE supports Msg3 repetition, and Msg3 repetition indication of freq3 indicates that Msg3 repetition is supported on all cells on freq3. So UE uses Threshold-3a to calculate S value, and finds Srxlev>0, so UE can reselect to Cell-8.

The present disclosure describes methods, apparatus, and computer-readable medium for wireless communication. The present disclosure addressed the issues with enhancing uplink coverage. The methods, devices, and computer-readable medium described in the present disclosure may facilitate the performance of wireless transmission, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
enhancing, by a user equipment (UE), an uplink coverage of a cell with a base station by:
receiving, by the UE, a configuration from the cell;
determining, by the UE, a random access (RA) resource based on the configuration and a measured downlink signal strength;
sending, by the UE, the RA preamble to the base station to request Msg3 repetition; and
receiving, by the UE, an RA response from the base station indicating transmission resource for Msg3 repetition.

2. (canceled)

3. The method according to claim 1, wherein:
the configuration comprises at least one of the following:
a list of synchronization signal block (SSB) indexes;
an SSB bitmap;
a reference signal received power (RSRP) threshold configuration;
a pathloss threshold configuration; or
a random access channel (RACH) resource configuration.

4. The method according to claim 3, wherein:
the list of SSB indexes indicates that any SSB in the list of SSB indexes is available for the UE to request Msg3 repetition.

5. The method according to claim 3, wherein:
the SSB bitmap indicates that any SSB in the SSB bitmap is available for the UE to request Msg3 repetition.

6. The method according to claim 3, wherein:
the RSRP threshold configuration comprises at least one of the following:
an Msg3 repetition RSRP threshold;
an SSB selection RSRP threshold; or
a set of two carrier selection RSRP thresholds.

7. (canceled)

8. The method according to claim 1, wherein:
the configuration is configured differently for at least one of the following:
different uplink carriers comprising a normal uplink (NUL) carrier and a supplementary uplink (SUL) carrier;
different bandwidth parts; or
different SSBs.

9. The method according to claim 6, wherein:
the set of two carrier selection RSRP thresholds comprises a first carrier selection RSRP threshold and a second carrier selection RSRP threshold, the first carrier selection RSRP threshold being applicable to a UE not supporting Msg3 repetition, and the second carrier selection RSRP threshold being applicable to a UE supporting Msg3 repetition.

10. (canceled)

11. The method according to claim 3, wherein:
the RACH resource configuration comprises at least one of the following:
a RACH occasion associated with an SSB;
at least one random access preamble associated with an SSB;
at least one preamble for RACH group A; or
at least one preamble for RACH group B.

12. The method according to claim 3, wherein:
the RACH resource configuration comprises at least one of the following parameters for triggering RACH with Msg3 repetition:
a preambleTransMax;
a preambleReceivedTargetPower;
a powerRampingStep;
an ra-ResponseWindow; or
an Msg3-DeltaPreamble.

13. (canceled)

14. (canceled)

15. The method according to claim 1, further comprising:
performing, by the UE, cell selection and reselection based on at least one access threshold, the at least one access threshold being configured by the base station via system information.

16. The method according to claim 15, wherein:
the at least one access threshold comprises at least one of the following:
a first threshold being applicable to a UE not supporting SUL and Msg3 repetition;
a second threshold being applicable to a UE supporting Msg3 repetition and not supporting SUL;
a third threshold being applicable to a UE supporting SUL and not supporting Msg3 repetition; or
a fourth threshold being applicable to a UE supporting SUL and Msg3 repetition.

17. (canceled)

18. (canceled)

19. A method for wireless communication, comprising:
enhancing, by a base station, an uplink coverage of a cell for a user equipment (UE) by:
sending, by the base station, a configuration to the UE, so that the UE determines a random access (RA) resource based on the configuration and a measured downlink signal strength;
receiving, by the base station, the RA preamble from the UE to request Msg3 repetition; and
sending, by the base station, an RA response to the UE indicating transmission resource for Msg3 repetition.

20. (canceled)

21. The method according to claim 19, wherein:
the configuration comprises at least one of the following:
a list of synchronization signal block (SSB) indexes;
an SSB bitmap;
a reference signal received power (RSRP) threshold configuration;
a pathloss threshold configuration; or
a random access channel (RACH) resource configuration.

22. The method according to claim 21, wherein:
the list of SSB indexes indicates that any SSB in the list of SSB indexes is available for the UE to request Msg3 repetition.

23. The method according to claim 21, wherein:
the SSB bitmap indicates that any SSB in the SSB bitmap is available for the UE to request Msg3 repetition.

24. The method according to claim 21, wherein:
the RSRP threshold configuration comprises at least one of the following:
an Msg3 repetition RSRP threshold;
an SSB selection RSRP threshold; or
a set of two carrier selection RSRP thresholds.

25. (canceled)

26. The method according to claim 19, wherein:
the configuration is configured differently for at least one of the following:
different uplink carriers comprising a normal uplink (NUL) carrier and a supplementary uplink (SUL) carrier;
different bandwidth parts; or
different SSBs.

27. The method according to claim 24, wherein:
the set of two carrier selection RSRP thresholds comprises a first carrier selection RSRP threshold and a second carrier selection RSRP threshold, the first carrier selection RSRP threshold being applicable to a UE not supporting Msg3 repetition, and the second carrier selection RSRP threshold being applicable to a UE supporting Msg3 repetition.

28-38. (canceled)

39. An apparatus comprising:
a memory storing instructions; and
a processor in communication with the memory, wherein, when the processor executes the instructions, the processor is configured to cause the apparatus to perform:
enhancing an uplink coverage of a cell with a base station by:
receiving a configuration from the cell;
determining a random access (RA) resource based on the configuration and a measured downlink signal strength;
sending the RA preamble to the base station to request Msg3 repetition; and
receiving an RA response from the base station indicating transmission resource for Msg3 repetition.

40. An apparatus comprising:
a memory storing instructions; and
a processor in communication with the memory, wherein, when the processor executes the instructions, the processor is configured to cause the apparatus to perform:
enhancing an uplink coverage of a cell for a user equipment (UE) by:
sending a configuration to the UE, so that the UE determines a random access (RA) resource based on the configuration and a measured downlink signal strength;
receiving the RA preamble from the UE to request Msg3 repetition; and
sending an RA response to the UE indicating transmission resource for Msg3 repetition.
